(19) United States
(12) Patent Application Publication
(10) Pub. No.: US 2003/0009496 A1
(43) Pub. Date: Jan. 9, 2003

(54) Bookmarks for world wide web documents with indicators of the hit rates for the web documents from the web sites sending the documents

(75) Inventors: Gerald Francis McBrearty, Austin, TX (US); Shawn Patrick Mullen, Buda, TX (US); Johnny Meng-Han Shieh, Austin, TX (US)

Correspondence Address: Volel Emile, International Business Machines Corporation, Intellectual Property Law Department, 11400 Burnet Road, Internal Zip 4054, Austin, TX, 78758, US

(73) Assignee: International Business Machines Corporation, Armonk, NY

(21) Appl. No.: 09/899,454

(22) Filed: Jul. 5, 2001

(51) Int. Cl. G06F 17/00

(52) U.S. Cl. 707/501.1; 707/513

(57) ABSTRACT

Activity rate information of the Web site providing the Web document at the particular time of day of the proposed request is presented to a user requesting a Web document at a receiving Web station so that the user may choose to request the Web document at a different time if there is an indication of high activity at the Web site which may cause a delay. Such activity rate information is presented as an indicator associated with a bookmark to the document of the proposed request. The rates of the numbers of specific Web documents transmitted from a source, i.e. hits during daily time cycles are tracked and indicators of said rates of transmission of said documents are displayed along with the respective bookmarks at the time that the selectable bookmarks are displayed.

### TECHNICAL FIELD

The present invention relates to computer managed communication networks, such as the World Wide Web (Web), and particularly to ease of use of interactive computer controlled display interfaces to such networks for substantially reducing the time and resources required to access Web documents from the Web.

### BACKGROUND OF RELATED ART

The past decade has been marked by a technological revolution driven by the convergence of the data processing industry with the consumer electronics industry. The effect has, in turn, driven technologies which have been known and available but relatively quiescent over the years. A major one of these technologies is the Internet related distribution of documents, media and programs. The convergence of the electronic entertainment and consumer industries with data processing exponentially accelerated the demand for wide ranging communications distribution channels and the Web or Internet, which had quietly existed for over a generation as a loose academic and government data distribution facility, reached “critical mass” and commenced a period of phenomenal expansion. With this expansion, businesses and consumers have direct access to all matter of documents, media and computer programs.

In addition, Hypertext Markup Language (HTML), which had been the documentation language of the Internet or Web for years, offered direct links between pages and other documentation on the Web and a variety of related data sources which were at first text and then evolved into media, i.e. “hypermedia”. This even further exploded the use of the Internet or Web. It was now possible for the Web browser or wanderer to spend literally hours going through document after document and accompanying media events in often less than productive excursions through the Web. These excursions often strained the user's time and resources. In order for the Internet to mature from its great expectations to solid commercial fruition, it will be necessary for the Internet to greatly reduce its drain on time and related resources. A significant source of this drain is in the Web page, the basic document page of the Web. Web pages still do not have much in the way of interface standards. Although many Web pages are professionally designed and, thus, relatively efficient to use, there are still a great many Web pages that are very cumbersome to access and to use, particularly when the user is making in depth searches.

The Web browsers, which have been available for over a decade as a Web document search and access tool, have provided users with the means of bookmarking and thereby saving Web documents. Bookmarking stores at a receiving display station direct links to the bookmarked documents and pages for future access so that the user may avoid cumbersome locating and addressing of the Web documents. While bookmarks have been a significant means of time saving on the Web, there remain many causes of user delay and frustration on the Web or Internet (terms are used interchangeably). A major source of such delay remains the fluctuations in demand, i.e. rates of “hits” or requests for Web pages/documents from Web sources or sites. Busy Web sites may be the cause of costly delays in retrieving Web documents. Many Web sites do track their activity rates, i.e. rates of hits per unit of time at the various times of the day or week. It would not be very practical for a user to request such information before requesting a particular Web page. From a busy Web site, activity rate information would likely be as slow to access as the Web page itself.

### SUMMARY OF THE PRESENT INVENTION

The present invention provides a system, method and program to present to a user at a receiving Web station, who wishes to request a Web document, activity rate information of the Web site providing the Web document at the particular time of day of the proposed request so that the user may choose to request the Web document at a different time if there is an indication of high activity at the Web site which may cause a delay. The key to the present invention is to provide such activity rate information as an indicator associated with a bookmark to the document of the proposed request.

Accordingly, the present invention comprises the combination of means associated with one of said receiving display stations for bookmarking of selected received Web documents to thereby store at said receiving display station, direct links to the sources of said Web documents; means for tracking the rates of the numbers of specific Web documents transmitted from a source during daily time cycles; and means at said receiving display station for providing at the displayed bookmarks for Web documents indicators of said rates of transmission of said documents at the time of said display.

The above-described receiving Web display station functions are carried out in a Web browser including the means for bookmarking of selected received Web documents and the means for providing at the displayed bookmark an indicator of said rate of transmission of said document at the time of said request. Preferably, the means in the Web browser for providing the indicator for the rate of transmission further includes means for requesting from the Web sites of each of a plurality of Web documents bookmarked at said receiving display station, the hourly hit rates for each bookmarked document and means for storing said hourly hit rates.

For best results, whenever a user bookmarks a Web document, the browser immediately requests from the Web site of the document the hourly hit rate of the bookmarked document. This is stored in association with the browser at the receiving Web display station. Accordingly, when the user subsequently wishes to use his bookmarks to access Web documents and brings up his list of bookmarks, there will be associated with each bookmark to a Web site that makes activity or hit rate information available, an indicator of this hit rate at the present time of day but based upon the previously requested stored information. Based upon a presumption of continuance, this information should be relatively timely, particularly if the sampling times for updates are relatively frequent. The user may then use such activity indicators to decide whether to request the bookmarked document at that particular time of day or wait for a less busy period.

However, every time a user requests a Web document, it is preferable to also request the Web site activity or hit rate data so that the stored activity data for the Web site may be updated.

Although the indicators of Web site activity rates associated with the respective bookmarks may be more comprehensive for certain purposes, we have found that special indicators of high and low hit rates for the bookmarked Web sites provide effective help for the user. Such high and low hit rates may be indicated by displayed bookmarks of different colors or by displaying the high hit rate bookmarks and low hit rate bookmarks in different menus.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter which is capable of implementing the receiving display station on which the received Web page or Web document may be processed by bookmarking with associated indicators of bookmarked documents' Web site activity rates in accordance with the present invention;

FIG. 2 is a generalized diagrammatic view of a Web portion upon which the present invention may be implemented;

FIG. 3 is a diagrammatic illustration of a display screen showing an initial Web page with a conventional bookmark index or menu;

FIG. 4 is the display screen of FIG. 3 showing the bookmark index of the present invention showing the use of indicators to point to both high and low rates for Web sites of the bookmarked documents at the time of day of the display;

FIG. 5 is a display screen like that of FIG. 4 indicating both high and low activity Web sources of bookmarked Web documents but wherein the high activity and low activity Web source bookmarks are listed in different menus;

FIG. 6 is a general flowchart of a program set up to implement the present invention for indicating the activity rates of the Web site sources of the bookmarked documents; and

FIG. 7 is a flowchart of an illustrative run of the program set up in FIG. 6.

### DETAILED DESCRIPTION OF THE PREFERRED EMBODIMENT

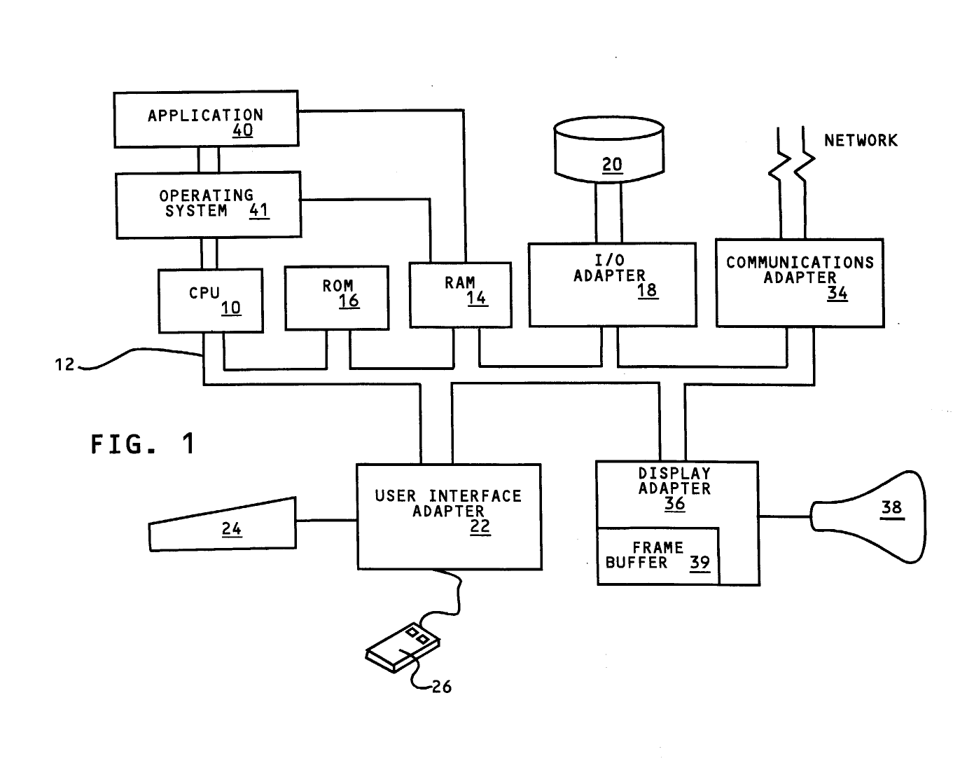

Referring to FIG. 1, a typical data processing terminal is shown which may function as a basic computer controlled network receiving terminal used in implementing the present invention for indicating at bookmarks the activity rates of the Web site sources of bookmarked Web documents. The data processing system shown may also be used for the Web servers supporting the Web site sources of the bookmarked documents. A central processing unit (CPU) 10, such as one of the PC microprocessors or workstations, e.g. RISC System/6000™ series available from International Business Machines Corporation (IBM), or Dell Corp.'s PC microprocessors, is provided and interconnected to various other components by system bus 12. An operating system 41 runs on CPU 10, provides control and is used to coordinate the function of the various components of FIG. 1. Operating system 41 may be one of the commercially available operating systems such as IBM's AIX 6000™ operating system or Microsoft's Windows98™ or WindowsNT™, as well as UNIX and other IBM AIX operating systems. Application programs 40, controlled by the system, are moved into and out of the main memory, Random Access Memory (RAM) 14. These programs include the programs of the present invention to be subsequently described in combination with any conventional Web browser, such as the Netscape 3.0™ or Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network enabling the data processing system to communicate with other such systems over a Local Area Network (LAN) or Wide Area Network (WAN), which includes, of course, the Web or Internet. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs for indicating the hourly activity rates of the sources of bookmarked documents according to the present invention. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods which may be related to the present invention. Since a major aspect of the present invention is directed to documents, such as Web pages, transmitted over networks, an understanding of networks and their operating principles would be helpful. We will not go into great detail in describing the networks to which the present invention is applicable. Reference has also been made to the applicability of the present invention to a global network such as the Internet. For details on Internet nodes, objects and links, reference is made to the text, Mastering the Internet, G. H. Cady et al., published by Sybex Inc., Alameda, Calif., 1996.

Any data communication system that interconnects or links computer controlled systems with various sites defines a communications network. A network may be as simple as two linked computers or it may be any combination of LANs or WANs. Of course, the Internet or Web is a global network of a heterogeneous mix of computer technologies and operating systems. Higher level objects are linked to the lower level objects in the hierarchy through a variety of network server computers. These network servers are the key to network distribution, such as the distribution of Web pages and related documentation. In this connection, the term documents, as used to describe data transmitted over the Web or other networks, is intended to include Web pages including displayable text, graphics and other images. This displayable information may be still, in motion or animated, e.g. animated GIF images.

Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly pp. 637-642, on HTML in the formation of Web pages. In addition, aspects of this invention will involve Web browsers. A general and comprehensive description of browsers may be found in the above-mentioned Mastering the Internet text at pp. 291-313.

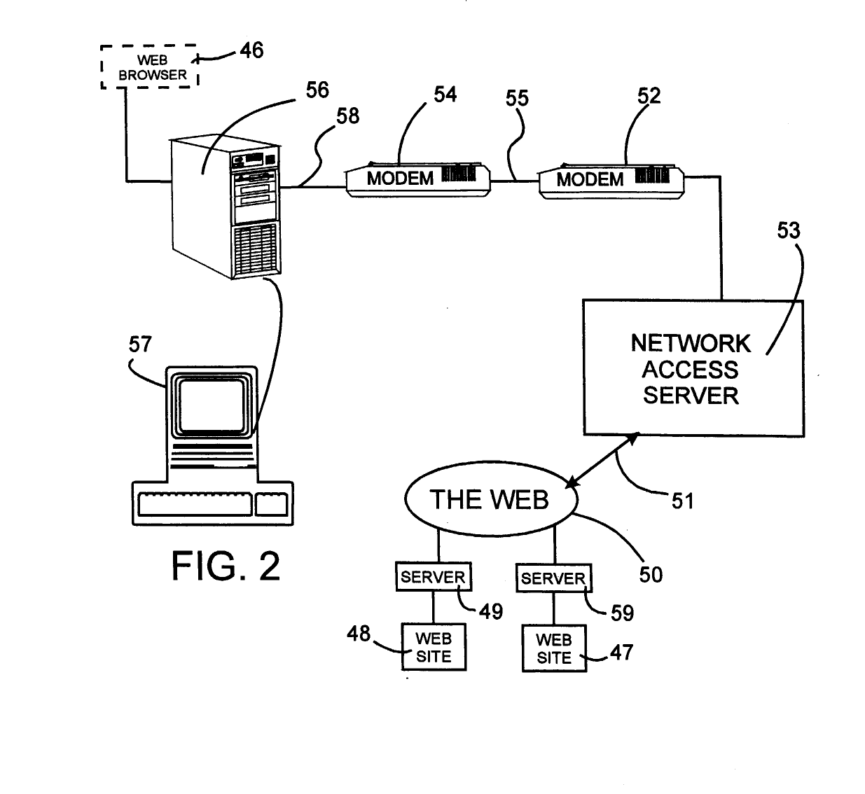

A generalized diagram of a portion of the Internet, which the computer 56 controlled display terminal 57 used for Web page or other document display of the present invention, is connected as shown in FIG. 2. Computer 56 and display terminal 57 are the computer system shown in FIG. 1 and connection 58 (FIG. 2) is the network connection shown in FIG. 1. Web browser program 46 is in computer 56 and carries out the programs to be subsequently described. Reference may be made to the above-mentioned Mastering the Internet, pp. 136-147, for typical connections between local display workstations to the Internet via network servers, any of which may be used to implement the system on which this invention is used. The system embodiment of FIG. 2 is one of these known as a host-dial up connection. Such host-dial up connections have been in use for over 30 years through network access servers 53, which are linked 51 to the Web 50. The servers 53 are maintained by a service provider to the client's display terminal 57. The host's server 53 is accessed by the client terminal 57 through a normal dial-up telephone linkage 58 via modem 54, telephone line 55 and modem 52. The HTML files representative of the Web pages are downloaded to display terminal 57 through controlling server 53 and computer 56 via the telephone line linkages from server 53 which may have accessed them from the Web 50 via linkage 51. Web sites 47 and 48 are representative of sources of Web documents that are accessed through the Web 50 via respective Web site servers 49 and 59. Servers 49 and 59 customarily track activities, i.e. hit rates at their respective Web sites over periods of time. The servers conventionally use this information in connection with the allocation of server/Web site functions and resources. As will be subsequently described, this activity information will be used in connection with bookmarks to indicate the Web site source activity rates of the bookmarked documents.

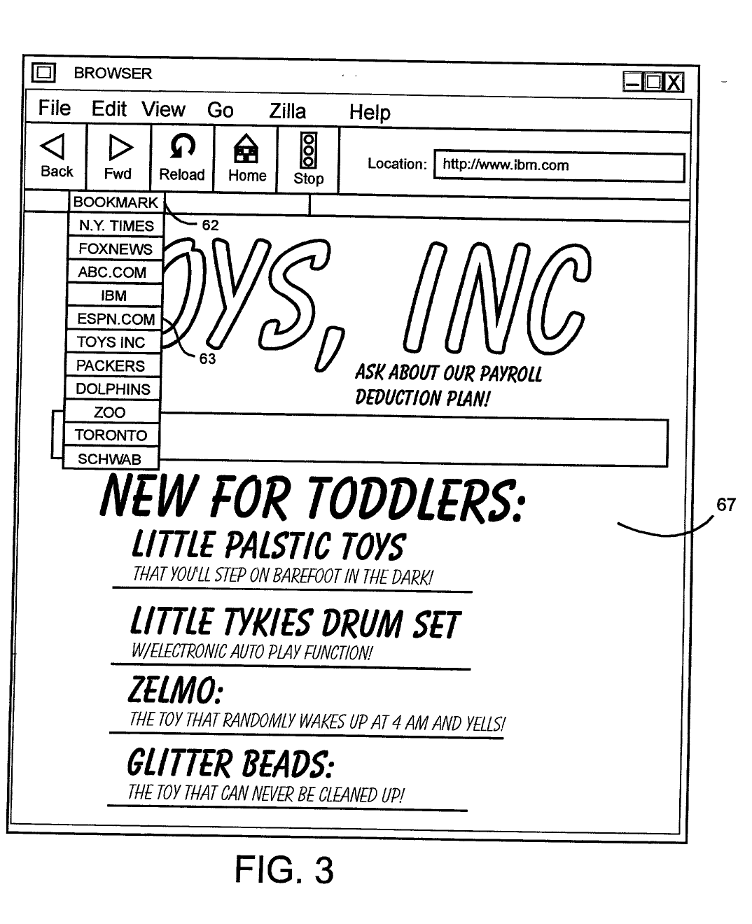

Now, with respect to FIGS. 3 through 5, we will provide an illustrative example of how the present invention may be used to provide indicators associated with bookmarks as to the activity state of the Web site sources of the bookmarked documents. When the screen images are described, it will be understood that these may be rendered by storing image and text creation programs, such as those in any conventional window operating system and in a standard browser program in the RAM 14 of the system of FIG. 1. The operating system is diagrammatically shown in FIG. 1 as operating system 41. The display screens of FIGS. 3 through 5 are presented to the viewer on display monitor 38 of FIG. 1. In accordance with conventional techniques, the user may control the screen interactively through a conventional I/O device, such as mouse 26, FIG. 1, which operates through user interface 22 to call upon programs in RAM 14 cooperating with the operating system 41 to create the images in frame buffer 39 of display adapter 36 to control the display on monitor 38.

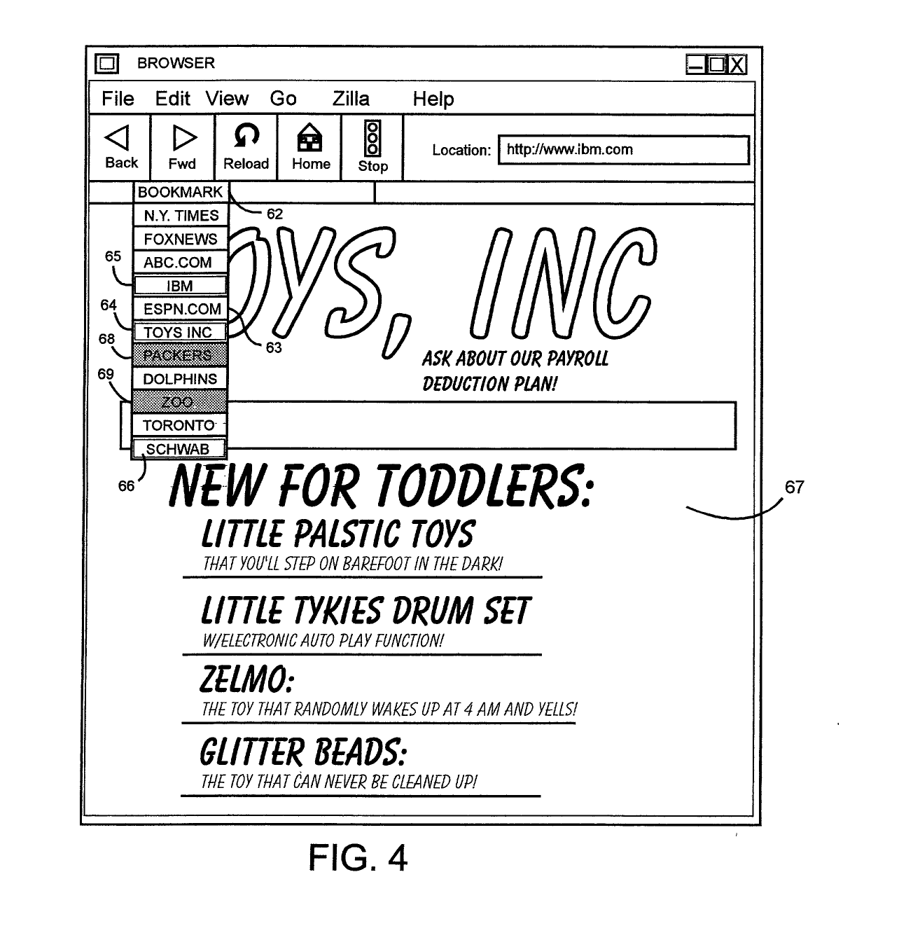

With respect to FIG. 3, we will describe an illustrative simple display screen browser interface that may be used to implement the browser program modifications of the present invention. Web page 67 is a simple Web document received from the Web at a receiving Web station. The bookmark selection item 62 has been clicked on to bring up menu or index 63 of bookmarks representing bookmarked documents. It is understood that in a user's system, there are usually many times the number of bookmarks are shown but this display interface has been simplified for purposes of illustration. It will also be understood that in accordance with this invention, which will be illustrated with respect to FIG. 4, when each item was originally bookmarked, the Web site from which the bookmarked item originated was queried to determine whether the site had “hit” rate information available for daily and weekly time period cycles. If the site had such hit rates available, they were stored at the receiving display station under control of the browser. These rates had been updated for each bookmark after its bookmarked document had been requested. Thus, on the menu 63 of FIG. 4, three bookmarks: IBM 65, TOYS INC. 64 and SCHWAB 66 are shown highlighted as an indication that at the day of the week and the time of day that the user is considering requesting bookmarked documents, the Web sites for IBM, TOYS INC. and SCHWAB are showing a high activity hit rate. On the other hand, the bookmarks PACKERS 68 and ZOO 69 are shown as hatched to indicate that the Web sites of these bookmarked documents are showing low activity hit rates. The user may then make his decision to request documents based on his own needs and requirements. The remaining bookmarks have no indication of either high or low activity Web site information, which indicates either that the Web site activity is normal or that the Web sites have not made activity information available to the public.

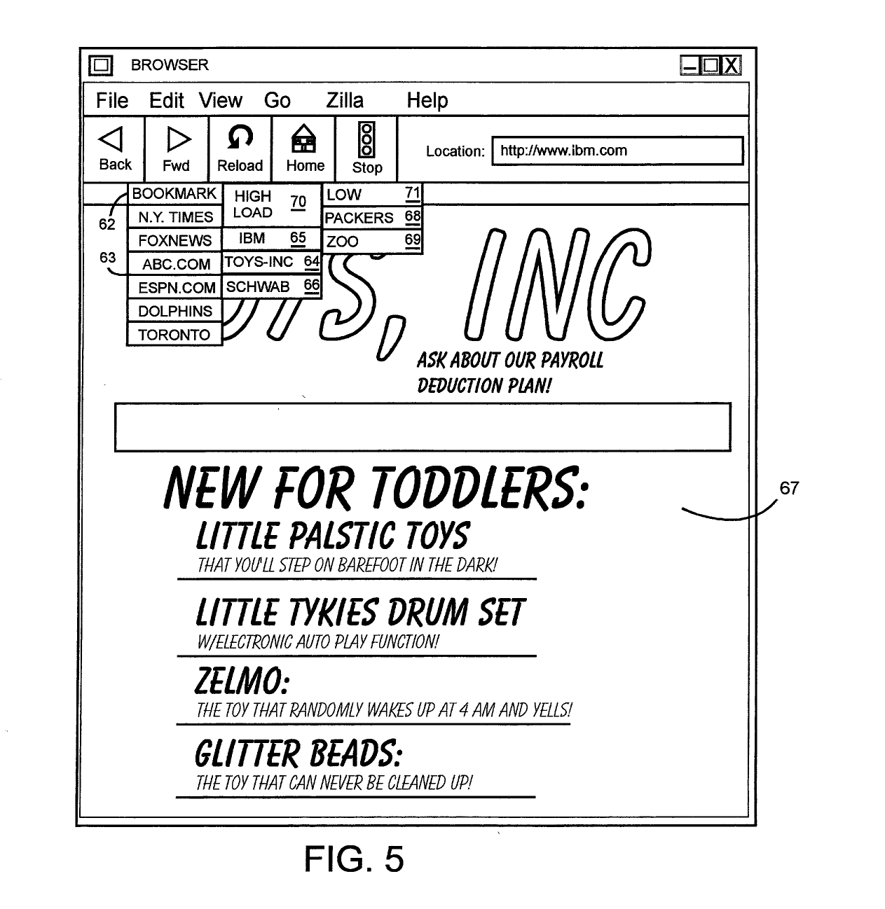

Now, with respect to FIG. 5, the bookmarks for the same high and low activity bookmark document Web sites as in FIG. 4 are shown except the bookmarks are distributed into three menus: normal activity Web site bookmarks 62, High Load or activity Web site bookmarks 70, and Low 71 activity Web site bookmarks.

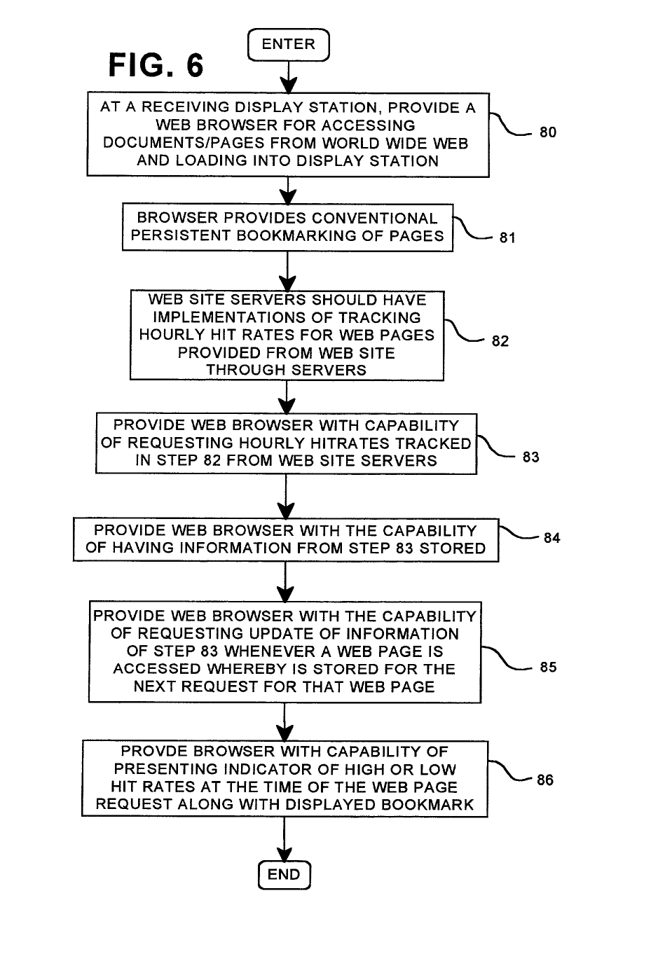

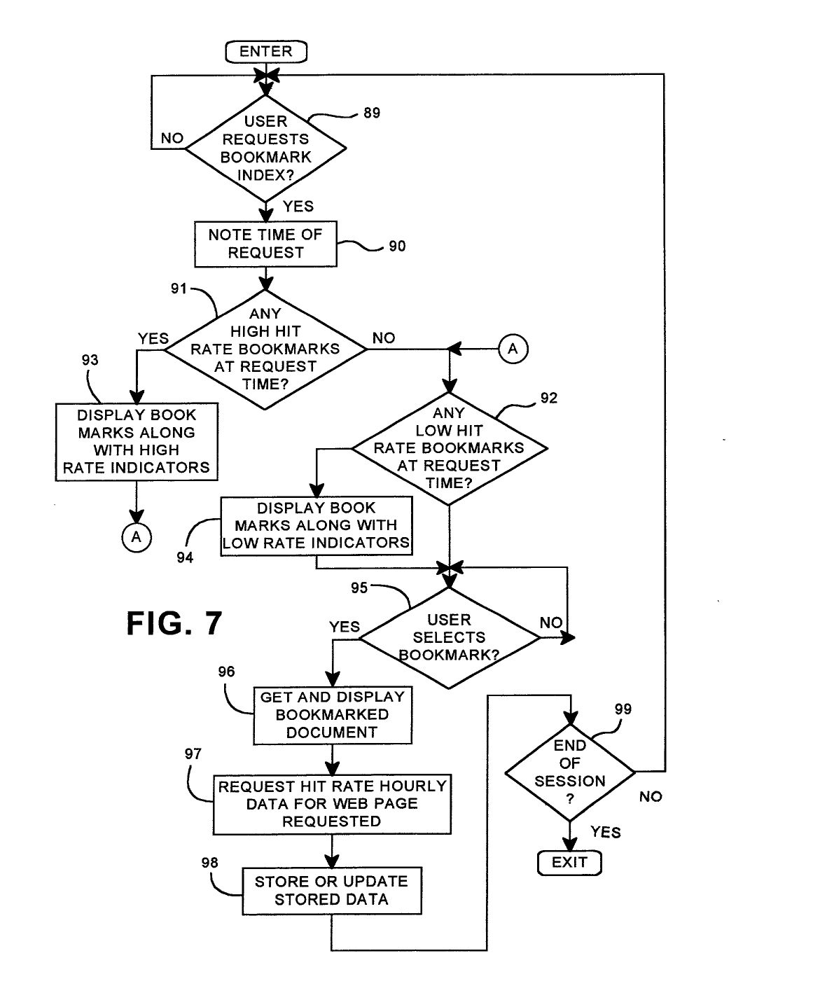

Now, with reference to FIGS. 6 and 7 we will describe a process implemented by the present invention in conjunction with the flowcharts of these figures. FIG. 6 is a flowchart showing the development of a process according to the present invention for presenting an indicator of the activity or hit rate level of the Web site sources of bookmarked documents in association with the bookmarks. With reference to FIG. 6, first, process step 80, a conventional Web browser program is provided at the Web page receiving display station, e.g. the computer controlled display of FIG. 1 or display station 56, 57 of FIG. 2. The Web browser provides for the bookmarking of Web pages in the conventional manner, step 81. Many Web site servers already should have implementations for tracking hourly hit rates for documents from their site daily throughout the week, step 82. If not, it would be advantageous for them to share this information with the public as it will, in accordance with this invention, serve to reduce Web site requests during peak activity times at the Web site. The Web browser at the receiving Web station is provided with the capability of getting this information from the Web site servers, step 83; and the browser also has the capability having this information stored under the control of the browser, step 84. The browser is also given the capability, step 85, of requesting an update of the stored information of step 84 whenever a bookmarked Web document is accessed. This update is stored and made available whenever the user subsequently reviews and considers which bookmarks to select. Finally, the browser is provided with the capability of indicating high or low activity Web sites on the listing of the user's bookmarked documents during subsequent requests for bookmarked documents, step 86.

The running of the process will now be described with respect to FIG. 7. In the process of the user accessing Web pages from the Web through the browser, a determination is made as to whether the user has requested the bookmark listing or menu, step 89. If No, the process returns to step 89 where such a request is awaited. If Yes, the time of day and day of the week is noted, step 90, and a determination is made, step 91, as to whether at the time of day and day of week of the request, the stored data for the Web site of the bookmarked page indicates high activity, i.e. hit rate. If Yes, then the high activity Web site bookmarks are displayed with their indicators to show such high activity, step 93. Then via branch “A”, or if the determination from step 91 is No high activity Web sites for the bookmarks, a further determination is made, step 92, as to whether at the time of day and day of week of the request, the stored data for the Web site of the bookmarked page indicates low activity, i.e. hit rate. If Yes, then the low activity Web site bookmarks are displayed with their indicators to show such high activity, step 94. The rest of the bookmarks are displayed normally. Then, a determination is made as to whether the user has selected any of the bookmarks: high rate, low rate or normal, step 95. If No, the process is returned to step 95 and such a selection is awaited. If Yes, then the bookmarked Web page is accessed and obtained through the browser, step 96, and the current hourly/daily hit rate for the bookmark's Web page site is requested through the browser, step 97. The stored data on this Web site's is updated to reflect this data, step 98. Also, if a received Web document is bookmarked for the first time, then this hit rate data for the document Web site is also obtained and stored. At this point, a determination may conveniently be made as to whether we are at the end of a session, step 99. If Yes, the session is exited. If No, the process is returned to step 89 where the next request for the bookmark menus is awaited.

It has been previously set forth that most servers supporting Web sites already have functioning programs for analyzing Web traffic at their particular sites. These functions are described in detail in the text, Internet: The Complete Reference, Millenium Edition, Margaret Young et al., published by Osborne/McGraw-Hill, 1999, particularly, Chapter 32, pp. 755-768, “Analyzing Web Traffic”. There are many commercial programs and services that a Web site may use to determine traffic, e.g. requests for particular Web pages. The type of data most useful in the present invention is weekly analysis data that gives an hourly profile of the Web page activity for a period of at least one week. With this type of profile stored for each bookmarked page, when a user views his displayed bookmarks, such data may be associated with each bookmark preferably in the form of indicators as described above. Thus, in determining whether to display high, low or normal activity indicators in association with bookmarks, the receiving Web station browser may use such standards, as provided by the Web site and described, for example, at pp. 765-766, of the above-mentioned text or the user may set his own levels of what level of activity he considers high or low activity levels.

One of the preferred implementations of the present invention is as a routine in an operating system made up of programming steps or instructions resident in RAM 14, FIG. 1, during computer operations. Until required by the computer system, the program instructions may be stored in another readable medium, e.g. in disk drive 20 or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Although certain preferred embodiments have been shown and described, it will be understood that many changes and modifications may be made therein without departing from the scope and intent of the appended claims.

What is claimed is:

1. In a World Wide Web (Web) communication network with user access via a plurality of data processor controlled interactive receiving display stations for displaying received hypertext documents of at least one display page containing text and images transmitted from sources on the Web, a system for bookmarking of selected received Web documents comprising:
means associated with one of said receiving display stations for bookmarking of selected received Web documents to thereby store at said receiving display station, direct links to the sources of said Web documents;
means for tracking the rates of the numbers of specific Web documents transmitted from a source during daily time cycles; and
means at said receiving display station for displaying in association with the displayed bookmarks for Web documents, data on the rates of transmission of said bookmarked documents at the time of said display.

2. The Web bookmarking system of claim 1 wherein said data on the rates of transmission are indicators at each of said bookmarks.

3. The Web bookmarking system of claim 2 wherein said Web document source is a Web site including:
said means for tracking further including means for tracking the hourly hit rates for requested specific Web documents.

4. The Web bookmarking system of claim 3 wherein said means for providing said indicator of said rate of transmission includes:
means for requesting from the Web sites of each of a plurality of Web documents bookmarked at said receiving display station, the hourly hit rates for each bookmarked document; and
means for storing said hourly hit rates.

5. The Web bookmarking system of claim 4 wherein said means for requesting the hourly hit rates of bookmarked Web documents periodically request the hit rates whereby said stored hit rates are periodically updated.

6. The Web bookmarking system of claim 5 wherein said indicator of the rate of transmission indicates both high and low hit rates.

7. The Web bookmarking system of claim 6 wherein said high and low hit rate bookmarked Web documents are indicated by displayed bookmarks of different colors.

8. The Web bookmarking system of claim 6 wherein said high and low hit rate bookmarked Web documents are indicated by displaying the high hit rate bookmarks and low hit rate bookmarks in different menus.

9. The Web bookmarking system of claim 6 further comprising:
Web browsing means at said receiving display station including:
said means for bookmarking of selected received Web documents; and
said means for providing at the displayed bookmark, an indicator of said rate of transmission of said document at the time of said request.

10. The Web bookmarking system of claim 9 wherein said means in said Web browser for providing said indicator of said rate of transmission includes:
means for requesting from the Web sites of each of a plurality of Web documents bookmarked at said receiving display station, the hourly hit rates for each bookmarked documents; and
means for storing said hourly hit rates.

11. The Web bookmarking system of claim 10 wherein said means in said Web browser for requesting the hourly hit rates of bookmarked Web documents periodically request the hit rates whereby said stored hit rates are periodically updated.

12. The Web bookmarking system of claim 11 wherein:
said Web browser further includes means for requesting bookmarked Web documents from their source Web sites; and
said means for periodically requesting hit rates request such hit rates when said bookmarked document is requested whereby said stored hit rates are updated for subsequent requests for said bookmarked document.

13. In a Web communication network with user access via a plurality of data processor controlled interactive receiving display stations for displaying received hypertext documents of at least one display page containing text, and images transmitted from sources on the Web, a method for bookmarking of selected Web documents comprising:
enabling the bookmarking of selected documents received at one of the receiving display stations to thereby store at said receiving display station, direct links to the sources of said Web documents;
tracking the rates of the numbers of specific Web documents transmitted from a source during daily time cycles; and
displaying at said receiving display station, in association with the displayed bookmarks for Web documents, data on the rates of transmission of the bookmarked document associated with each bookmark at the time of said display.

14. The bookmarking method of claim 13 wherein said data on the rates of transmission are indicators of said rate of transmission at each of said bookmarks.

15. The bookmarking method of claim 14 wherein said Web document source is a Web site at which the step of tracking is carried out, and further includes the step of tracking the hourly hit rates for requested specific Web documents.

16. The bookmarking method of claim 15 wherein said step of providing said indicator of said rate of transmission includes the steps of:
requesting from the Web sites of each of a plurality of Web documents bookmarked at said receiving display station, the hourly hit rates for each bookmarked document; and
storing said hourly hit rates.

17. The bookmarking method of claim 16 wherein said step of requesting the hourly hit rates of bookmarked Web documents periodically request the hit rates whereby said stored hit rates are periodically updated.

18. The bookmarking method of claim 17 wherein said step of indicating the rate of transmission indicates both high and low hit rates.

19. The bookmarking method of claim 18 wherein said high and low hit rate bookmarked Web documents are indicated by displayed bookmarks of different colors.

20. The bookmarking method of claim 19 wherein said high and low hit rate bookmarked Web documents are indicated by displaying the high hit rate bookmarks and low hit rate bookmarks in different menus.

21. The bookmarking method of claim 18 further comprising:
a Web browsing process at said receiving display station including:
said step of bookmarking of selected received Web documents; and
said step of providing at the displayed bookmark, an indicator of said rate of transmission of said document at the time of said request.

22. The bookmarking method of claim 21 wherein said step in said Web browsing process for providing said indicator of said rate of transmission includes:
requesting from the Web sites of each of a plurality of Web documents bookmarked at said receiving display station, the hourly hit rates for each bookmarked document; and
storing said hourly hit rates.

23. The bookmarking method of claim 22 wherein said step in said Web browser for requesting the hourly hit rates of bookmarked Web documents periodically requests the hit rates whereby said stored hit rates are periodically updated.

24. The bookmarking method of claim 23 wherein:
said Web browsing process further includes the step of requesting bookmarked Web documents from their source Web sites; and
said step of periodically requesting hit rates requests such hit rates when said bookmarked document is requested whereby said stored hit rates are updated for subsequent requests for said bookmarked document.

25. A computer program having code recorded on a computer readable medium for bookmarking of selected received Web documents in a Web communication network with user access via a plurality of data processor controlled interactive receiving display stations for displaying received hypertext documents of at least one display page containing text and images transmitted from sources on the Web, said program comprising:
means associated with one of said receiving display stations for bookmarking of selected received Web documents to thereby store at said receiving display station, direct links to the sources of said Web documents;
means for tracking the rates of the numbers of specific Web documents transmitted from a source during daily time cycles; and
means at said receiving display station for displaying in association with the displayed bookmarks for Web documents, data on the rates of transmission of said bookmarked documents at the time of said display.

26. The computer program of claim 25 wherein said data on the rates of transmission are indicators at each of said bookmarks.

27. The computer program of claim 26 wherein said Web document source is a Web site including:
said means for tracking further including
means for tracking the hourly hit rates for requested specific Web documents.

28. The computer program of claim 27 wherein said means for providing said indicator of said rate of transmission includes:
means for requesting from the Web sites of each of a plurality of Web documents bookmarked at said receiving display station, the hourly hit rates for each bookmarked documents; and
means for storing said hourly hit rates.

29. The computer program of claim 28 wherein said means for requesting the hourly hit rates of bookmarked Web documents periodically request the hit rates whereby said stored hit rates are periodically updated.

30. The computer program of claim 29 wherein said indicator of the rate of transmission indicates both high and low hit rates.

31. The computer program of claim 30 wherein said high and low hit rate bookmarked Web documents are indicated by displayed bookmarks of different colors.

32. The computer program of claim 30 wherein said high and low hit rate bookmarked Web documents are indicated by displaying the high hit rate bookmarks and low hit rate bookmarks in different menus.

33. The computer program of claim 30 further comprising:
a Web browser program at said receiving display station including:
said means for bookmarking of selected received Web documents; and
said means for providing at the displayed bookmark, an indicator of said rate of transmission of said document at the time of said request.

34. The computer program of claim 33 wherein said means in said Web browser program for providing said indicator of said rate of transmission includes:
means for requesting from the Web sites of each of a plurality of Web documents bookmarked at said receiving display station, the hourly hit rates for each bookmarked documents; and
means for storing said hourly hit rates.

35. The computer program of claim 34 wherein said means in said Web browser program for requesting the hourly hit rates of bookmarked Web documents periodically request the hit rates whereby said stored hit rates are periodically updated.

36. The computer program of claim 35 wherein:
said Web browser program includes means for requesting bookmarked Web documents from their source Web sites; and
said means for periodically requesting hit rates request such hit rates when said bookmarked document is requested whereby said stored hit rates are updated for subsequent requests for said bookmarked document.
